(19) United States
(12) Patent Application Publication
(10) Pub. No.: US 2008/0159358 A1
(43) Pub. Date: Jul. 3, 2008

(54) Unknown Destination Traffic Repetition

(76) Inventors: David Ruiz, Barcelona (ES); Veronica Romero, Barcelona (ES); Jonathan Ephraim David Hurwitz, Edinburgh (GB)

Correspondence Address: CARR & FERRELL LLP, 2200 GENG ROAD, PALO ALTO, CA, 94303, US

(21) Appl. No.: 11/619,167

(22) Filed: Jan. 2, 2007

(51) Int. Cl. H04B 3/36

(52) U.S. Cl. 375/211

(57) ABSTRACT

Central coordinator and proxy coordinator information typically found in powerline communications standards, such as the HomePlug standards, is used to ensure proper communication of a data packet directed toward an unknown destination. By using the central coordinator nodes and the proxy coordinator nodes to repeat the data packet according to a set of forwarding rules, the data packet can be transmitted to each node in the network using a tree topology that avoids generating loops that may result in packet storms. When the destination node is located, subsequent data packets can be sent to the destination node through a known route.

### CROSS-REFERENCES

This nonprovisional U.S. patent application is related to nonprovisional U.S. patent application No. 11/562,380 filed Nov. 21, 2006 and entitled “Network Repeater” which is incorporated by reference herein.

### BACKGROUND

1. Field of the Invention

The invention is in the field of communications and more specifically in the field of signal repeaters.

2. Related Art

When nodes are added to a communication network, a node may be instructed to transmit a message to a destination that is not yet known to the node. When signals are communicated to a destination node that is unknown to the source of the signal, the signal must be repeated by nodes (“repeater nodes”) along a variety of different paths until the signal reaches its intended destination. This repeating may be performed by a repeater that receives the signal and promptly resends a copy of the signal. The signal may be sent in a broadcast or a unicast mode. In a broadcast mode, the signal is transmitted to a number of receiving locations simultaneously. In a unicast mode, the signal is transmitted from one node and is addressed specifically to another node. A signal sent in a unicast mode is typically ignored by all nodes but the node to which it is addressed. In a multicast mode, the signal is addressed specifically to more than one other node.

One problem with repeating a signal is that repeaters are difficult to use in networks that are not linearly structured. For example, if a network is in the form of a mesh or a ring, a repeater may itself receive and resend a signal that it previously sent. This signal may, thus, be repeated indefinitely. In mesh networks including more than one repeater, copies of a signal may multiply when each signal sent by one repeater is received and rebroadcast by more than one repeater. This multiplication is referred to as a broadcast storm and may overwhelm a network. A broadcast storm is more likely to occur when a signal is directed toward an unknown destination node because the signal must be repeated to all possible node locations until the destination node receives the signal.

Some systems have tried to avoid broadcast storms by ensuring that the network does not contain any loops. As such, these networks use a unicast or multicast algorithm such as the Spanning Tree Algorithm to transmit the signal to each of the nodes. The Spanning Tree Algorithm, however, requires a significant initialization period when a node is added to or removed from the network. Further, the Spanning Tree Algorithm further requires tens of kilobytes of memory in each node to be implemented in a network.

Powerline communication networks are one example of a mesh network in which a broadcast storm could occur if repeaters are used. In powerline communication networks, which are typically structured in a mesh architecture, the signal is transmitted, or broadcast, to the nodes along a shared powerline and may be received by all nodes that are within range of the transmitting node.

One standard for powerline communications, HomePlug AV, includes nodes that are configured to operate as central coordinators and proxy coordinators. In the HomePlug AV standard, the central coordinator node is configured to recognize other nodes within a certain range. These other nodes may include proxy coordinator nodes that are configured to recognize the central coordinator node and other nodes within a certain range. Every node in the network is coupled to at least the central coordinator or a proxy coordinator. Through a hierarchal relationship, the central coordinator node and the proxy coordinators can coordinate the entire network. Typically, the roles of the central coordinator and the proxy coordinator can be dynamically assigned to different nodes within the network over time.

### SUMMARY

Central coordinator and proxy coordinator information found in powerline communications standards, such as the HomePlug standards, is used to ensure proper communication of a data packet directed toward an unknown destination. The central coordinator nodes and the proxy coordinator nodes repeat the data packet to each node in the network using a communication tree topology. The communication tree topology avoids generating loops that may result in broadcast storms. When the destination node is located, subsequent data packets can be sent directly to the destination node along a known path.

In the network, a node is configured to generate and address a data packet to a destination node. If the location of the destination node is unknown, the node transmits the data packet to a coordinator node, i.e., a central coordinator node or a proxy coordinator node, within the communication tree topology. A node receives a data packet directed to an unknown destination, and determines whether it is itself the unknown destination. If the node is not the unknown destination, the node can then determine if it is operating as a central coordinator node or a proxy coordinator node. If the node is not operating as a coordinator node, then the node does not forward the packet. If the node is operating as a central coordinator node or a proxy coordinator node, the node is configured to repeat the data packet to one or more visible nodes according to a set of forwarding rules described further herein. These forwarding rules are configured to prevent the packet from being received by a node more than once. As such, they reduce the probability of broadcast storms. The one or more visible nodes receiving the data packet may comprise a node operating as a central coordinator node or a proxy coordinator node. Thus, the data packet directed toward an unknown destination is repeated to other nodes until it reaches the destination node. The destination node, after identifying itself, optionally transmits a reply back to the source of the data packet to enable direct communication between the source node and the destination node along a known path.

Various embodiments of the invention include a network comprising a plurality of nodes, at least one node configured to communicate over a powerline, including, a first node configured to operate in a central coordinator role and including logic configured to receive a first message directed toward an unknown destination and repeat the first message to those members of the network visible to the first node other than a node from which the first message was received. This system optionally further comprises a second node visible to the first node and configured to operate in a proxy coordinator role and including logic configured to receive a second message from a member of a proxy network and repeat the second message to the first node, the logic further configured to receive the first message from the first node and repeat the first message to the members of the proxy network.

Various embodiments of the invention include a node comprising first logic configured to, in a central coordinating role, receive a message directed toward an unknown destination from a second node and repeat the message to a plurality of other nodes visible to the node, and second logic configured to, in a proxy coordinating role, receive the message directed toward the unknown destination from a third node operating in the central coordinating role and repeat the message to members of a proxy network, and further configured to, in the proxy coordinating mode, receive the message directed toward the unknown destination from one of the members of the proxy network and repeat the message to the third node.

Various embodiments of the invention include a method, comprising at a first node, receiving a message directed to an unknown destination, determining whether the unknown destination comprises the first node, determining whether the first node is operating in a central coordinator mode, if the first node is operating in the central coordinator mode, transmitting the message to a plurality of other nodes visible to the first node, determining whether the first node is operating in a proxy coordinator mode, if the first node is operating in a proxy coordinator mode, determining whether the message was received from a second node operating in a central coordinator mode, if the message was received from the second node, transmitting the message to members of a proxy network, and if the message was not received from the second node, transmitting the message to the second node.

Various embodiments of the invention include a network comprising a plurality of nodes configured to communicate over a powerline, the network comprising a first node configured to repeat a first data packet directed toward an unknown destination over the powerline according to a set of forwarding rules associated with a central coordinator role.

Various embodiments of the invention include a system of communication nodes comprising a powerline network comprising a plurality of nodes, a first node of the plurality of nodes configured to repeat a data packet addressed to a second node and sent from a third node, logic used to repeat the data packet requiring less than nine kilobytes of additional memory, and optionally wherein the first node is configured to repeat the data packet once the second node is attached to the network.

### BRIEF DESCRIPTION OF THE DRAWINGS

FIG. 1 illustrates a network in which various embodiments of the invention may be practiced;

FIG. 2 illustrates various embodiments of a node;

FIG. 3 illustrates an exemplary embodiment of a communication tree according to the present invention;

FIG. 4 illustrates various embodiments of a method of transmitting a message to a destination; and

FIG. 5 illustrates various embodiments of a method of processing a message received by a node.

### DETAILED DESCRIPTION

A mesh network includes one central coordinator node and may optionally include one or more proxy coordinator node. Packet storms, which are similar to broadcast storms, are substantially avoided when a broadcast, unicast or multicast message is directed toward an unknown destination by forwarding messages based on the roles that particular nodes may have when they receive the messages. These roles may include a central coordinator role, a proxy coordinator role, and a non-coordinating role.

Central coordinator and proxy coordinator roles are assigned to nodes using methods such as those defined in powerline communications standards. These assignments may be dynamic. In a network, one node will be assigned the role of central coordinator node. If all other nodes in the network are not visible to the central coordinator node, one or more nodes may be assigned roles as proxy coordinator nodes. Every node in the network will be in communication with at least one proxy coordinator node or the central coordinator node. Control of the network may be managed from the central coordinator node through the proxy coordinator nodes.

When a message is sent by a first node to an unknown destination, the message is initially sent to the node that coordinates the first node, i.e., the central coordinating node or one of the proxy coordinating nodes. An unknown destination is a node to which a data packet is addressed without the transmitting node knowing at least the start of a path to the destination through the network. The action that a node takes when it receives a message to an unknown destination depends on the role of the receiving node. By following a set of role-dependent forwarding rules, as further described herein, the message may be transmitted to every node in a network without being delivered to a repeating node more than once. Further, because of the role-dependent forwarding rules, a packet transmitted through the network may be repeated by repeaters operating in unicast, multicast and/or broadcast modes. The possibility of a packet storm is, thus, reduced.

Unlike the Spanning Tree Algorithm, the network does not require an initialization period if a node is added to or removed from the network. Thus, a packet may be set to or sent by a node once that node is added to the network, e.g., without an initialization delay. Further, the implementation of the various embodiments described herein may require less than nine, seven, five, three, two, or one kilobytes of additional memory in each node. For example, in one embodiment the packet forwarding algorithms disclosed herein can be implemented using less than 9 kilobytes of additional memory above what is required to operate other functions of the node.

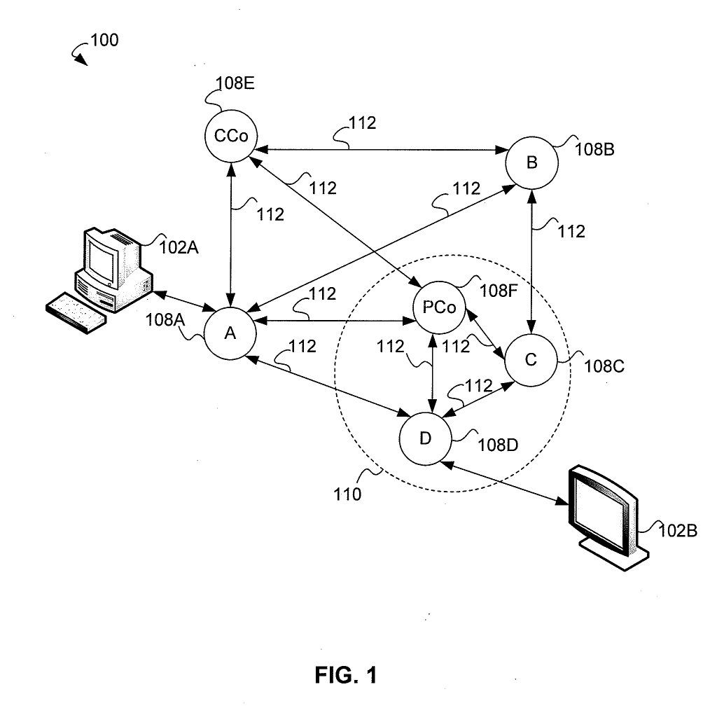

FIG. 1 illustrates a network 100 in which various embodiments of the invention may be practiced. The network 100 comprises exemplary devices 102A-102B and a plurality of nodes 108A-108F. One of the plurality of nodes is configured to operate in a central coordinator role, e.g., node 108E. One or more of the plurality of nodes is configured to operate in a proxy coordinator role, e.g., node 108F. The devices 102A and 102B are connected to nodes 108A and 108D, respectively. Further, nodes 108C-108F may be connected to other devices (not shown). The devices, such as devices 102A and 102B, may include home entertainment system components, large and small appliances, personal computers, communication devices, and/or the like. Each node 108A-108F either performs the central coordinating role or is in direct communication with a member of nodes 108A-108F that is performing a coordinating role. For example, nodes 108A, 108B, and 108F are in direct communication with node 108E, which is performing the central coordinating role. Likewise, nodes 108C and 108D are in direct communication with node 108F, which is performing a proxy coordinating role. Nodes 108C and 108D are not in direct communication with node 108E. As such, these nodes are included within a proxy network 110 of node 108F. A message from node 108C to node 108E may be relayed through node 108F.

Arrows 112 represent direct communication links between nodes. These communication links may include, for example, unicast and/or multicast channels for sending data packets between nodes. If a destination of a data packet is unknown, each non-coordinating node 108A-108D transmits the data packet directly to the nearest node performing a coordinating role. (The identity of this node is typically known.) For example, a data packet addressed to an unknown destination and originating at node 108C would first be sent to node 108F. Likewise, a data packet addressed to an unknown destination an originating at node 108A would first be sent to node 108E. If a data packet addressed to an unknown destination originates at a node having a proxy-coordinator role, then the data packet is sent to all nodes within the proxy network 110 of the proxy-coordinator node and to a node having a coordinating role at the next level in the hierarchical structure of the central and proxy-coordinators. For example, a data packet originating at the proxy-coordinating (PCo) node 108F would be sent to nodes 108D, 108C and the central coordinating (CCo) node 108E.

The CCo node 108E and the PCo node 108F may be negotiated among the nodes according to a home networking standard, such as the HomePlug AV standards. Typically, any node within the network 100 may operate as a CCo node or PCo node, and these roles may change over time. For example, if the device associated with CCo node 108E is unplugged or removed from the network 100, the CCo node 108E is renegotiated among the nodes 108A-108F. For example, node 108B may be selected to operate as the next CCo node.

The network 100 may comprise a hybrid network that includes powerline communications and one or more other type of communications such as Ethernet, WIFI, and/or the like. In these embodiments, a signal may be conveyed using several different types of communications. These communications types may be bridged using a network device that is configured to communicate using two or more types of communication.

The network 100 comprises one central coordinator node (CCo) 108E. The central coordinator node 108E is substantially similar to the nodes 108A-D and may be connected to a fifth device (not shown). The central coordinator node 108E is further configured for performing a central coordinating role according to various powerline communications standards. In the central coordinator role, the CCo node 108E can communicate in a unicast, multicast or broadcast mode to visible nodes in the network 100. Visible nodes comprise nodes in the network 100 that can be communicated without the use of a repeater. For example, the visible nodes associated with the CCo node 108E include node 108A, node 108B, and the proxy coordinator 108F. Nodes 108C and 108D are not visible to the CCo node 108E.

The network 100 may comprise one or more proxy coordinator nodes (PCo) 108F. Like the CCo node 108E, the PCo node 108F is substantially similar to the nodes 108A-108D and may be connected to a sixth device (not shown). The PCo node 108F operates in a proxy coordinating mode according to powerline communications standards. In the proxy coordinator mode, the PCo 108E can communicate to at least other nodes within the proxy network 110 and the CCo node 108E. The proxy network 110 may further comprise a second PCo (not shown) that is able to unicast and/or multicast to nodes within a second proxy network (not shown). As such, Network 100 may include a hierarchy of proxy-coordinator nodes under the central coordinating node.

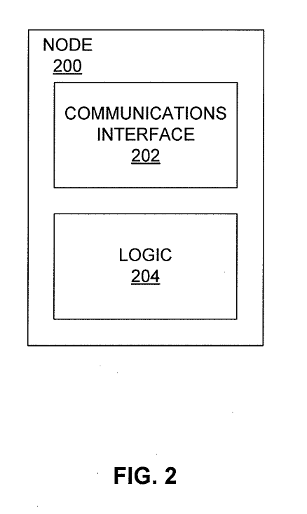

FIG. 2 illustrates various embodiments of a node 200. The node 200 may perform a non-coordinating role, a central coordinating role, or a proxy coordinating role. The node 200 comprises, at least, a communication interface 202 and logic 204. The node 200 may be identified by a MAC address.

The communications interface 200 is configured to receive and transmit messages over the network 100. The messages are typically comprised of data packets. The communications interface 202 may comprise a network card, an 802.3 Ethernet interface, a powerline communications interface including a plug to connect to a power outlet, a WIFI transceiver, and the like. The communications interface 202 may comprise more than one communications interface to enable communication over more than one type of network. For example, the node 200 may be able to receive a data packet via an Ethernet connection and repeat the data packet over a powerline communication network.

Logic 204 is configured to dynamically operate in a central coordinating role, a proxy coordinating role, and/or a non-coordinating role. The logic 204 is configured to process packets received from other nodes in the network 100, optionally generate packets to transmit via the network 100, and determines whether to repeat received packets according to the mode in which the node is operating.

In some embodiments, logic 204 comprises a processor configured to execute software read from a computer readable media. In some embodiments, logic 204 comprises firmware stored in an electronic circuit configured to execute the firmware. In some embodiments, logic 204 comprises hardware configured to perform logical operations described herein. Logic 204 may further include memory, such as read-only memory, FLASH memory, and/or random access memory. This memory may include software configured to perform logical operations describe herein.

In the non-coordinating role, the logic 204 is configured to generate and transmit data packets to a known destination. If the destination of a data packet is unknown, the logic 204 is configured to transmit the data packet to the nearest node performing a coordinator role. For example, if the node is part of a proxy network, the logic 204 is configured to transmit the data packet to the node performing the proxy coordinator role within that proxy network.

When a node receives a data packet, the logic 204 is configured to check to see whether the node is the destination node. If the node is the destination node, the logic 204 is configured such that the node processes the message according to a powerline communications standard. If the node is not the destination node, and not in a coordinating role, then the logic 204 configured such that the data packet is not forwarded.

In a CCo node operating in a central coordinating role, the logic 204 is configured to first determine if the node is the destination node. If the node is the destination node, the logic 204 is configured such that the node processes the message according to a powerline communications standard. If the node is not the destination node, the logic 204 is configured to repeat the received data packet (addressed to an unknown destination) to other visible nodes. In the central coordinating role, the logic 204 does not repeat the data packet to the node from which the data packet was received, but optionally repeats the data packet to all other visible nodes. For example, if CCo node 108E receives a data packet addressed to an unknown destination from node 108A, then the data packet will be repeated to nodes 108B and 108F.

In a PCo node operating in a proxy coordinating role, the logic 204 is configured to first determine if the node is the destination node. If the node is the destination node, the logic 204 is configured such that the node processes the message according to a powerline communications standard. If the node is not the destination node, the logic 204 is configured to repeat the received data packet (addressed to an unknown destination). With the exception that the received data packet is not repeated to the node from which it was received, the data packet is repeated a) to all the nodes in the proxy network managed by the PCo node and b) to the node that is managing the PCo node. The node managing the PCo node may be the CCo node or another PCo node at the next level in a hierarchy of PCo nodes between the CCo node and the PCo node having received the data packet. For example, if PCo node 108F receives a data packet, addressed to an unknown destination (other then PCo node 108F), from CCo node 108E, then the data packet will be repeated to nodes 108C and 108C. If PCo node 108F receives a data packet addressed to an unknown destination (other then PCo node 108F), from node 108C, then the data packet will be repeated to node 108D and CCo node 108E.

These forwarding rules result in data packets addressed to an unknown destination being communicated via a communication tree in which the data packets are received by each node once. This typically reduces the probability of a broadcast storm.

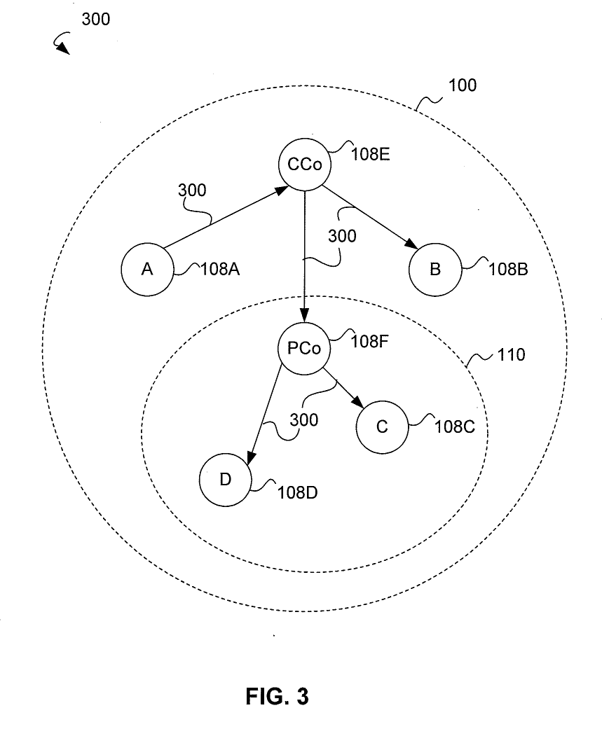

For example, FIG. 3 illustrates an exemplary embodiment of a communication tree 300 according to the present invention. Arrows 310 are used to indicate the direction of data packet communication. The communication tree 300 shown in FIG. 3 is adopted in the network 100 when the node 108A sends a data packet directed toward an unknown destination to prevent a broadcast storm. The data packet is first sent to CCo node 108E, this node being the highest level coordinating node visible to node 108A.

The CCo node 108E is configured to transmit the packets directed toward an unknown destination to, optionally all, nodes visible to the CCo node 108E except for the node that sent the packet. The PCo node 108F is configured to repeat the packet depending on the node that the PCo node 108F received the packet from. If the packet was received from the CCo node 108E, the PCo node 108F repeats the packet to, optionally all, the nodes in the proxy network 110 that PCo node 108F coordinates. However, if the packet was received from a node within the proxy network 110, the PCo node 108F repeats the data packet to the CCo node and those nodes within the proxy network 110, except for the node from which the data packet was received.

In the example shown, node 108A is a source node that generates a packet directed toward an unknown destination. Node 108A transmits the packet to the CCo node 108E. When the CCo node 108E receives the data packet from node 108A, the CCo node 108E repeats the packet to the nodes visible to the CCo node 108E, except for the source node 108A. For example, in the communication tree 300, the packet is repeated to node 108B and PCo node 108F, because CCo node 108E is performing the central coordinating role. The PCo node 108F, having received the packet from the CCo node 108E, will repeat the packet to the nodes in the proxy network 110 comprising nodes 108C and 108D. Thus, the packet directed toward an unknown destination has been transmitted to each node in the network 100 without creating any loops that may generate a broadcast storm.

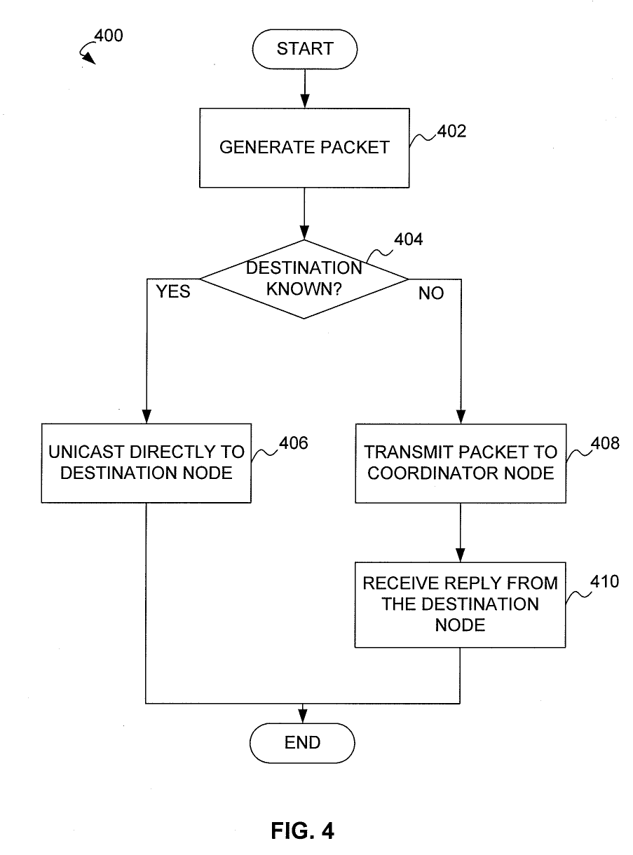

FIG. 4 illustrates various embodiments of a method 400 of transmitting a message to a destination. The method 400 may be performed by a node such as one of the nodes 108A-108D, the CCo node 108E, or the PCo node 108F. The method may be performed over a network including powerline communications.

In a step 402, a source node generates a packet to transmit to another node, possibly of unknown destination. The packet includes an address (e.g., a MAC address) indicating the destination of the packet. However, the destination will be considered unknown if no path from the source node to the destination node is known. In a step 404, the node determines whether the destination is known. If the destination is known to the source node, the node optionally unicasts the packet to the destination node in a step 406 along a known path. For example, node 108A may unicast the packet directly to node 108D if this path is known.

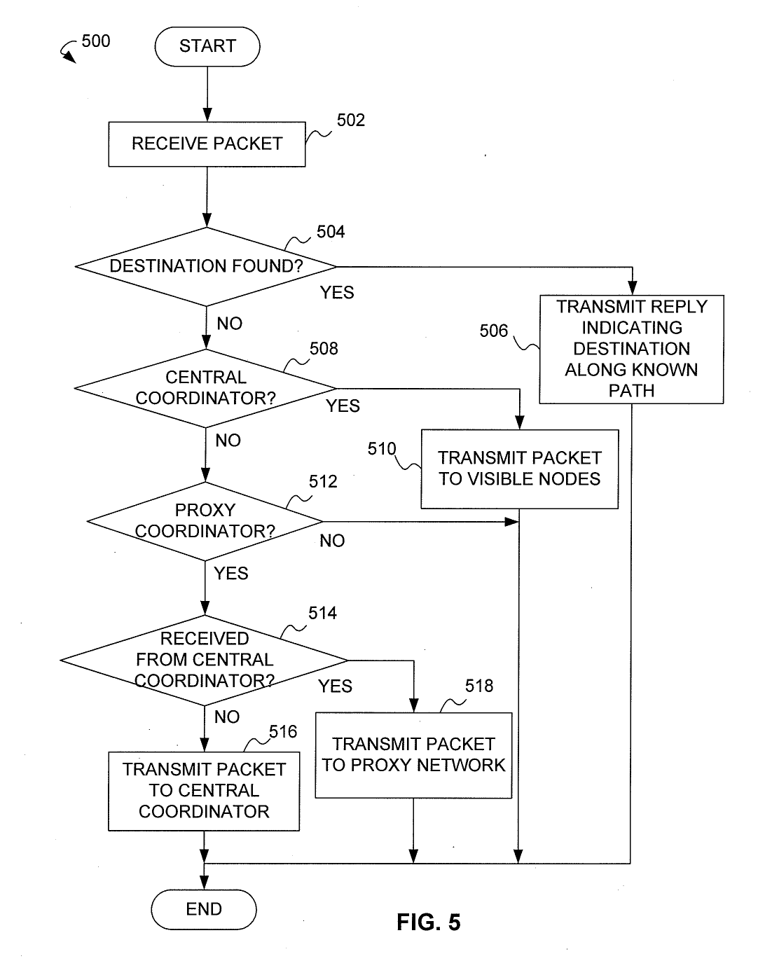

If the destination is not known, the source node transmits the packet to the highest level visible coordinator node, in a step 408. For example, node 108A would transmit to CCo node 108E because CCo node 108E is a higher level coordinating node than PCo node 108F. If the transmitting node is associated with a proxy network, such as proxy network 110, the node transmits the data packet to the node performing the proxy coordinator role for that proxy network, such as node 108F. However, if the node is not associated with a proxy network, the node transmits the data packet to the node performing the central coordinator role, such as node 108E. The data packet may then be repeated to the destination node using, for example, the method illustrated in FIG. 5. When the destination node receives the data packet, the destination node may send a reply (acknowledgement) data packet. The source node optionally receives the reply data packet from the destination node, in a step 410. Information within the reply data packet may be used to determine a path within the network 100 to the destination node via other nodes. Based on the reply, the source node may then transmit another data packet to the destination node along the known path.

FIG. 5 illustrates various embodiments of a method 500 of processing a message received by a node. The logic 204 within the nodes 108A-F may be configured perform the method 500 upon receiving a data packet.

In a step 502, a node receives a data packet. In a step 504, the node determines whether it is the destination of the data packet or knows where the destination is located within the network 100. For example, if a destination MAC address within the data packet matches a MAC address associated with the node, the node is the destination of the packet. The data packet may be received from the source node, from a CCo node 108E or from a PCo node 108F. If the node that received the data packet is the destination node, then in a step 506 the node optionally transmits a reply data packet addressed to the source node identifying itself as the destination node.

In a step 508, if the node is not the destination node, the node determines whether it is operating in the central coordinating mode. If the node is operating in the central coordinator mode, then in a step 510 the node transmits the data packet to the nodes that are visible to the node except for the node that sent the data packet to the node. These visible nodes may include one or more nodes operating as proxy coordinator nodes.

If the node is not operating in a central coordinator mode, then in a step 512 the node determines whether it is operating in a proxy coordinator mode. If the node is operating in the proxy coordinator mode, then in a step 514 the node determines whether it received the packet from the central coordinator node. If the packet was not received from the central coordinator, then in a step 516 the node transmits the packet to the central coordinator node and members of the proxy network coordinated by the node (other than the node from which the data packet was received. If the packet was received from the central coordinator node, then in a step 518 the node transmits the packet to the nodes in the proxy network that the node is coordinating.

Several embodiments are specifically illustrated and/or described herein. However, it will be appreciated that modifications and variations are covered by the above teachings and within the scope of the appended claims without departing from the spirit and intended scope thereof. For example, in some embodiments, the proxy network may comprise sub-proxy networks coordinated by a node performing a sub-proxy role. The sub-proxy network is formed if a proxy network includes another proxy coordinator node associated with a separate proxy network. The sub-proxy coordinator node operates in the proxy coordinator role but acts as though the proxy coordinator node is the central coordinator node. Further, there may be several proxy coordinator nodes that are all coordinated by the central coordinator node. Further, in some embodiments, the orders of steps of methods described herein may be performed in alternative orders. Further, the forwarding rules described herein may be altered somewhat. For example, a PCo 108F may be configured to repeat data packets that it receives from members of the proxy network 100 only to CCo 108E, while CCo node 108E is configured to repeat data received from PCo node 108F back to PCo node 108F. This variation in forwarding rules will produce results similar to the forwarding rules discussed elsewhere herein. In various embodiments, the packets may be broadcast, unicast, and/or multicast between nodes.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A network comprising a plurality of nodes, the network comprising:
a first node configured to communicate over a powerline and to operate in a central coordinator role and including logic configured to receive a first message directed toward an unknown destination and repeat the first message to those members of the network visible to the first node other than a node from which the first message was received.

2. The network of claim 1, wherein each of the plurality of the nodes is associated with a media access control (MAC) address.

3. The network of claim 1, further comprising a third node associated with the plurality of the nodes, the third node configured to transmit the first message to the first node.

4. The network of claim 3, wherein the third node is configured to communicate directly to one of the plurality of the nodes based on a reply.

5. The network of claim 1, wherein the central coordinator role is negotiated according to a HomePlug powerline communications standard.

6. The network of claim 1, further comprising a second node visible to the first node and configured to operate in a proxy coordinator role and including logic configured to receive a second message from a member of a proxy network and repeat the second message to the first node, the logic further configured to receive the first message from the first node and repeat the first message to the members of the proxy network.

7. The network of claim 6, wherein the proxy coordinator role is negotiated according to a HomePlug powerline communications standard.

8. A node comprising:
first logic configured to, responsive to a central coordinating role, receive a message directed toward an unknown destination from a second node and repeat the message to a plurality of other nodes visible to the node.

9. The node of claim 8, further comprising third logic configured to, in a non-coordinating role, receive a message having an unknown destination, determine whether it is the unknown destination, and, if the node is the unknown destination, transmit a reply to the second node.

10. The node of claim 8, further comprising second logic configured to, responsive to a proxy coordinating role, receive the message directed toward the unknown destination from a third node operating in the central coordinating role and repeat the message to members of a proxy network, and further configured to, in the proxy coordinating mode, receive the message directed toward the unknown destination from one of the members of the proxy network and repeat the message to the third node.

11. The node of claim 9, further comprising fourth logic configured to dynamically change operation status between the central coordinating role, a proxy coordinating role, and a non-coordinating role.

12. The node of claim 8, wherein the central coordinator role is based on a HomePlug AV standard.

13. The node of claim 8, wherein the proxy coordinator role is based on a HomePlug AV standard.

14. The node of claim 8, wherein the unknown destination is indicated by a Media Access Control (MAC) address.

15. The node of claim 8, wherein the first logic and the second logic are implemented using less than nine kilobytes of memory.

16. A method comprising:
at a first node, receiving a message directed to an unknown destination;
determining whether the unknown destination comprises the first node;
determining whether the first node is operating in a central coordinator mode; and
if the first node is operating in the central coordinator mode, transmitting the message to a plurality of other nodes visible to the first node.

17. The method of claim 16, further comprising transmitting a reply to a third node, if the unknown destination comprises the node.

18. The method of claim 16, wherein the central coordinator mode is based on a HomePlug standard.

19. The method of claim 16, further comprising:
determining whether the first node is operating in a proxy coordinator mode,
if the first node is operating in a proxy coordinator mode, determining whether the message was received from a second node operating in a central coordinator mode,
if the message was received from the second node, transmitting the message to members of a proxy network, and
if the message was not received from the second node, transmitting the message to the second node.

20. The method of claim 19, wherein the proxy coordinator mode is based on a HomePlug standard.

21. The method of claim 16, wherein the unknown destination is indicated by a Media Access Control (MAC) address.

22. A system of communication nodes comprising:
a network comprising a plurality of nodes configured to communicate over a powerline, the network comprising:
a first node configured to repeat a first data packet directed toward an unknown destination over the powerline according to a set of forwarding rules associated with a central coordinator role.

23. The system of claim 22, further including a second node being visible to the first node and configured to repeat the first data packet over the powerline according to a set of forwarding rules associated with a proxy coordinator role, the set of forwarding rules associated with the central coordinating role and the set of forwarding rules associated with the proxy coordinating role being configured such that the first data packet is repeated without causing a packet storm.

24. The system of claim 22, wherein logic configured to repeat the first data packet requires less than nine kilobytes of additional memory.

25. A system of communication nodes comprising:
a powerline network comprising a plurality of nodes, a first node of the plurality of nodes configured to repeat a data packet addressed to a second node and sent from a third node, logic used to repeat the data packet requiring less than nine kilobytes of additional memory.

26. The system of claim 25, wherein the first node is configured to repeat the data packet once the second node is attached to the network.
